(19) United States
(12) Patent Application Publication
(10) Pub. No.: US 2018/0358922 A1
(43) Pub. Date: Dec. 13, 2018

(54) SLEW DRIVE WITH INTEGRATED SENSORS AND TRANSDUCERS

(71) Applicants: Adam Plesniak, Huntington beach, CA (US); Mark Henderson, La Verne, CA (US)

(72) Inventors: Adam Plesniak, Huntington beach, CA (US); Mark Henderson, La Verne, CA (US)

(21) Appl. No.: 16/005,888

(22) Filed: Jun. 12, 2018

Related U.S. Application Data
(60) Provisional application No. 62/518,301, filed on Jun. 12, 2017.

(51) Int. Cl. H02S 20/32; F16H 19/00; F16H 57/039; F24S 30/425

(52) U.S. Cl. CPC H02S 20/32; F16H 19/001; F16H 2057/02026; F24S 30/425; F16H 2019/008; F16H 57/039

(57) ABSTRACT

A single axis slew driving system with integrated sensors and transducers including a housing defining a cavity, a rotor assembly rotatably mounted within the cavity supporting an axle with a gear plate affixed thereto and gear teeth positioned along a periphery thereof, a driving gear rotatably mounted in the housing meshing with the gear teeth, and a drive motor attached to the driving gear for rotation of the driving gear and one of: a thermocouple embedded in the housing to provide an indication of the temperature adjacent the driving gear; an absolute position sensing system including a movement tracking device mounted in the housing and extending into the cavity of the housing; limit switches mounted on the outer periphery of the housing; an integrated accelerometer and communication assembly; and an integrated torque routing solenoid mounted on an outer periphery of the housing.

### CROSS-REFERENCE TO RELATED APPLICATION

This application claims the benefit of U.S. Provisional Patent Application No. 62/518,301, filed 12 Jun. 2017.

### FIELD OF THE INVENTION

This invention relates to slew drives and more specifically to a slew drive with integrated sensors and transducers.

### BACKGROUND OF THE INVENTION

Slew drives are mechanical actuators which take input motion from an input gear or worm and rotates, generally at low speeds, an output gear of larger size in order to accomplish an intended continuous or partial radial motion. For example, a slew drive can be used in a single axis solar tracker which is a device that holds PV panels (panels of photovoltaic sensors) and rotates the panels from east to west throughout the day to increase the output of electrical energy from the panels and reduce cosine loss.

Slew drives are often used in conjunction with different types of sensors for various applications. These sensors may include but are not limited to thermocouples, absolute position sensors, limit switches, accelerometers (for position and speed), communication sensors (wifi, zigbee, etc.), and solenoids (for torque/load routing). In general, prior art slew drives were manufactured as purely mechanical systems and any sensors are added after production. The addition of sensors after manufacture requires much precise work which can result in damage and wear or additional cost/complexity, since in many instances the original mechanical system must be disassembled for the sensors to be properly positioned.

It would be highly advantageous, therefore, to remedy this and other deficiencies inherent in the prior art.

Accordingly, it is an object of the present invention to provide a new and improved slew drive with integrated sensors and transducers.

It is another object of the present invention to provide a new and improved slew drive with integrated sensors and transducers that is inexpensive, and easy and efficient to operate.

It is another object of the present invention to provide a new and improved solar tracker slew drive with integrated sensors and transducers that is simpler to incorporate into a solar panel assembly.

It is another object of the present invention to provide a new and improved solar tracker slew drive with integrated sensors and transducers that is able to withstand higher external forces without changing the structure.

### SUMMARY OF THE INVENTION

Briefly to achieve the desired objects and advantages of the instant invention a single axis slew driving system with integrated sensors and transducers is provided. The system includes a slew drive having a housing with a central portion defining a cavity, a rotor assembly rotatably mounted within the cavity and supporting an output axle, the rotor assembly including a gear plate affixed to the axle and including an arcuate set of gear teeth positioned along a periphery thereof, a driving gear rotatably mounted in the housing so as to mesh with the arcuate set of gear teeth on the gear plate in the cavity in the housing, and a drive motor mounted on the housing and attached to the driving gear for rotation of the driving gear, whereby the rotor assembly including the gear plate and attached output axle are rotated in response to rotation of the drive motor. The system further includes at least one of: a thermocouple embedded in the housing so as to extend within the cavity to provide an indication of the temperature adjacent the driving gear chamber at contact points of the driving gear and the arcuate set of gear teeth on the gear plate and external monitoring apparatus; an absolute position sensing system including a movement tracking device mounted in the housing and extending into the cavity of the housing and into communication with an outer surface of the rotatably positioned rotor assembly; limit switches mounted on the outer periphery of the housing, a first of the limit switches including an activating plunger with an end positioned to be depressed when the driving gear drives the gear plate clockwise to a first rotary limit and a second of the limit switches including an activating plunger with an end positioned to be depressed when the driving gear drives the gear plate counterclockwise to a second rotary limit; an integrated accelerometer and communication assembly including an accelerometer coupled to a communications protocol, the assembly integrated directly onto one of the output axle or the gear plate directly measuring rotary movement and communicating the measurements to an external control system; and an integrated torque routing solenoid mounted on an outer periphery of the housing, the solenoid including an armature having an extended position and a withdrawn position, and in the extended position the armature extending through an opening in the housing and into an opening in the gear plate.

The desired objects and advantages of the instant invention are further achieved in a preferred embodiment of a single axis driving system including a housing with a central portion defining a cavity with a rotor assembly rotatably mounted within the cavity and supporting an output axle, the rotor assembly including a gear plate affixed to the axle and including an arcuate set of gear teeth positioned along a periphery thereof. The system also includes a driving gear rotatably mounted in the housing so as to mesh with the arcuate set of gear teeth on the gear plate in the cavity in the housing and a drive motor mounted on the housing and attached to the driving gear for rotation of the driving gear, whereby the rotor assembly including the gear plate and attached output axle are rotated in response to rotation of the drive motor. The system further includes at least one of: a thermocouple embedded in the housing so as to extend within the cavity to provide an indication of the temperature adjacent the driving gear chamber at contact points of the driving gear and the arcuate set of gear teeth on the gear plate and external monitoring apparatus; an absolute position sensing system including a movement tracking device mounted in the housing and extending into the cavity of the housing and into communication with an outer surface of the rotatably positioned rotor assembly; limit switches mounted on the outer periphery of the housing, a first of the limit switches including an activating plunger with an end positioned to be depressed when the driving gear drives the gear plate clockwise to a first rotary limit and a second of the limit switches including an activating plunger with an end positioned to be depressed when the driving gear drives the gear plate counterclockwise to a second rotary limit; an integrated accelerometer and communication assembly including an accelerometer coupled to a communications protocol, the assembly integrated directly onto one of the output axle or the gear plate directly measuring rotary movement and communicating the measurements to an external control system; and an integrated torque routing solenoid mounted on an outer periphery of the housing, the solenoid including an armature having an extended position and a withdrawn position, and in the extended position the armature extending through an opening in the housing and into an opening in the gear plate.

The desired objects and advantages of the instant invention are further achieved in a specific embodiment of a single axis driving system including a housing with a central portion defining a cavity, a rotor assembly rotatably mounted within the cavity and supporting an output axle, the rotor assembly including a gear plate affixed to the axle and including an arcuate set of gear teeth positioned along a periphery thereof, a worm gear rotatably mounted in a cylindrical cavity portion of the housing so as to mesh with the arcuate set of gear teeth on the gear plate in the cavity in the housing, and a drive motor mounted on the housing and attached to the worm gear for rotation of the worm gear, whereby the rotor assembly including the gear plate and attached output axle are rotated in response to rotation of the drive motor. The system further includes at least one of: a thermocouple embedded in the housing so as to extend within the cavity to provide an indication of the temperature adjacent the worm gear chamber at contact points of the worm gear and the arcuate set of gear teeth on the gear plate and external monitoring apparatus; an absolute position sensing system including a movement tracking device mounted in the housing and extending into the cavity of the housing and into communication with an outer surface of the rotatably positioned rotor assembly; limit switches mounted on the outer periphery of the housing, a first of the limit switches including an activating plunger with an end positioned to be depressed when the driving gear drives the gear plate clockwise to a first rotary limit and a second of the limit switches including an activating plunger with an end positioned to be depressed when the driving gear drives the gear plate counterclockwise to a second rotary limit; an integrated accelerometer and communication assembly including an accelerometer coupled to a communications protocol, the assembly integrated directly onto one of the output axle or the gear plate directly measuring rotary movement and communicating the measurements to an external control system; and an integrated torque routing solenoid mounted on an outer periphery of the housing, the solenoid including an armature having an extended position and a withdrawn position, and in the extended position the armature extending through an opening in the housing and into an opening in the gear plate.

### BRIEF DESCRIPTION OF THE DRAWINGS

Specific objects and advantages of the invention will become readily apparent to those skilled in the art from the following detailed description of a preferred embodiment thereof, taken in conjunction with the drawings in which:

FIG. 1 is a perspective view of a generic solar panel assembly illustrating the various components and relative positions;

FIGS. 2A and 2B illustrate a full perspective view and a cross-sectional perspective view, respectively, of a slew drive with embedded thermocouple in the worm input cavity, which is the area most subject to heat generation due to worm/gear friction, in accordance with the present invention;

FIGS. 3A, 3B, and 3C illustrate a full perspective view, a cross-sectional perspective view, and an enlarged perspective view of a portion of the slew drive, respectively, of the slew drive with internally mounted absolute position sensor, in accordance with the present invention;

FIGS. 4A and 4B illustrate a full perspective view and a cross-sectional perspective view, respectively, of the slew drive with limit switches integrated internal to the drive, in accordance with the present invention;

FIGS. 5A and 5B illustrate a full perspective view and a cross-sectional perspective view, respectively, of limit switches integrated external to the drive, in accordance with the present invention;

FIGS. 6A and 6B illustrate a full perspective view and an enlarged partial view, respectively, of the slew drive with integrated accelerometer and communication assembly, in accordance with the present invention; and

FIGS. 7A, 7B, and 7C illustrate a full perspective view and two cross-sectional perspective views, respectively, of the slew drive and an integrated torque routing solenoid, in accordance with the present invention.

### DETAILED DESCRIPTION OF THE DRAWINGS

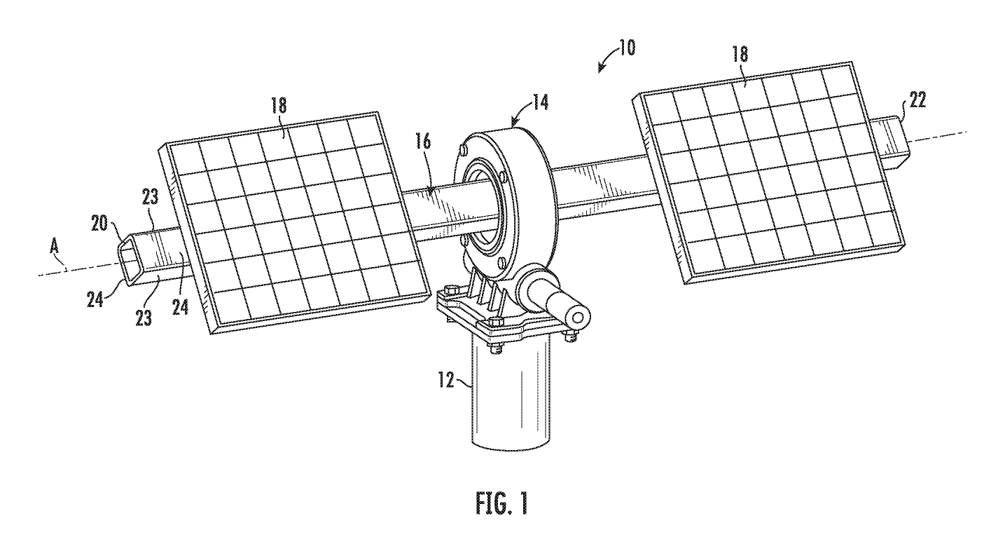

Turning to FIG. 1, which illustrate a generic solar panel assembly generally designated 10, is provided simply to illustrate the background or surroundings for the present slew drive in one specific application. It will be understood by those of ordinary skill in the art that a slew drive according to the present invention can be used in other applications. Assembly 10 includes a support post 12, a slew drive 14 carried by post 12, a transverse support member 16 extending through and rotated by slew drive 14, and solar panels 18 carried by transverse support member 16. Transverse support member 16 is mounted for rotation about a longitudinal axis A. It will be understood that while transverse support member 16 is illustrated as tubular for convenience in understanding, in the present invention it will be constructed to attach to output collars illustrated in the remaining figures and described in detail below. Transverse support member 16 is carried by slew drive 14 (simplified in this view for convenience in understanding) at a midpoint between ends 20 and 22 to provide a weight balance between the ends. Solar panels 18 are coupled to transverse support member 16 intermediate slew drive 16 and end 20, and intermediate slew drive 16 and end 22. It will be understood by those skilled in the art that the entire assembly is oriented with axis A generally extending north and south (depending upon the geographical location). By rotating transverse support member 16 around longitudinal axis A, solar panels 18 can be adjusted to face the sun as it moves through the daytime sky, maximizing energy conversion.

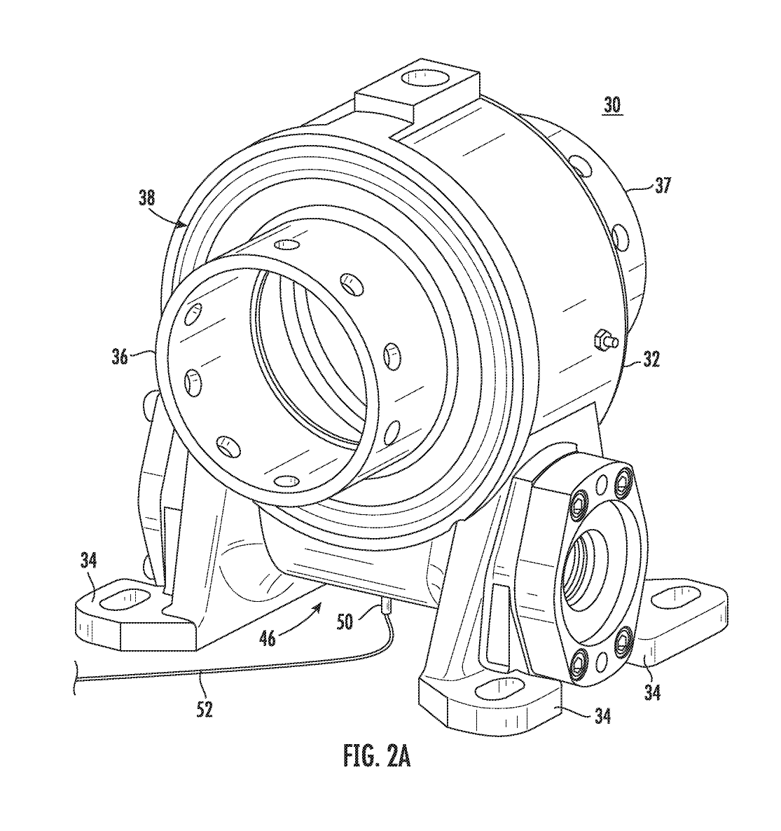

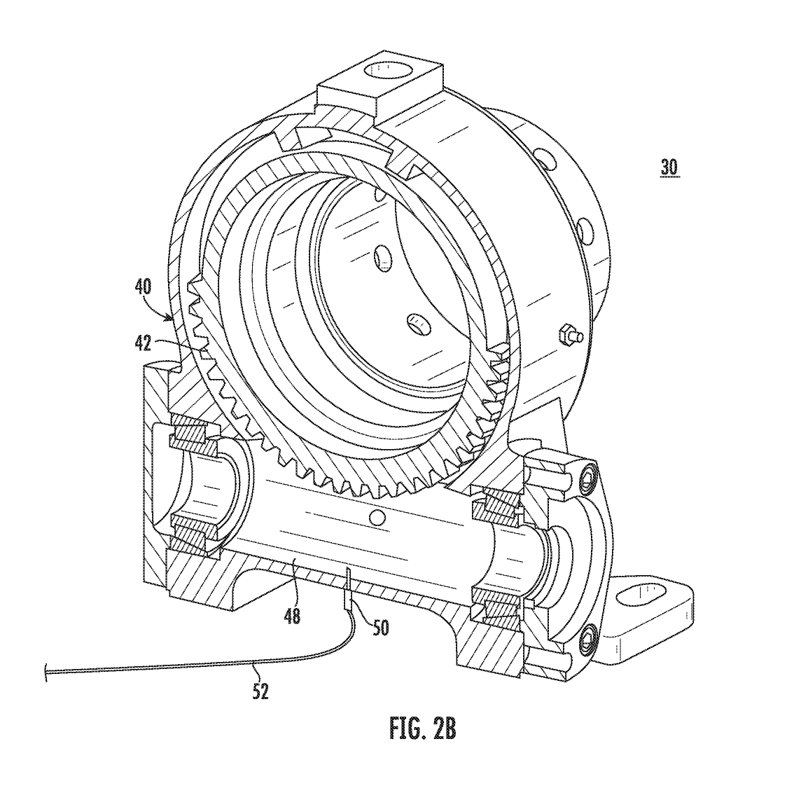

Turning now to FIGS. 2A and 2b, a slew drive 30 in accordance with the present invention is illustrated. Slew drive 30 includes a housing 32 with integral feet 34 provided to securely mount slew drive 30 on a support post (see FIG. 1). Output collars 36 and 37 are rotatably mounted within housing 32 and extend outwardly in opposite directions to have solar panels attached thereto, generally as described in conjunction with FIG. 1. Output collars 36 and 37 are constructed as part of a rotor assembly 38 which includes, in addition to structure for rotatable mounting, a gear plate 40, illustrated in FIG. 2B. Gear plate 40 has gear teeth 42 extending radially outwardly around approximately one half of the periphery from approximately a horizontal diameter through slew drive 30 (i.e. from approximately 90° to 270°). Gear teeth 42 are positioned to engage a worm drive 46 extending from one side of housing 32 to the other at the lower periphery of gear plate 40. Worm drive 46 is rotatably mounted within a worm chamber 48, illustrated in cross-section in FIG. 2B. A drive motor (not shown) is mounted on one end of worm chamber 48 and attached to the worm input in worm drive 46. It will be understood that the drive motor turns the worm gear which is meshed with gear teeth 42 and turns rotor assembly 38. Since gear teeth 42 extend for 180°, it will be clear that the motor can turn rotor assembly 38, and attached output collars 36 and 37 through 180°.

In addition to the slew drive described above, the present single axis slew driving system with integrated sensors and transducers includes one or more of a thermocouple, an absolute position sensing system, limit switches, integrated accelerometer and communication assemblies, and an integrated torque routing solenoid. Generally, the integrated sensors and transducers included will depend upon the specific application of the slew drive and the operating conditions. For example in the instance in which the slew drive is used to drive solar panels in a solar tracking system, all of the various additions might be included. Each of the additions is described in more detail below in conjunction with a specific embodiment of a slew drive.

A thermocouple 50 is embedded in worm chamber 48 so as to extend within the chamber and provide an indication of the temperature of grease within worm chamber 48 near the contact points of the worm and the gear teeth. An electrical line 52 extends from thermocouple 50 to an external monitoring station (not shown).

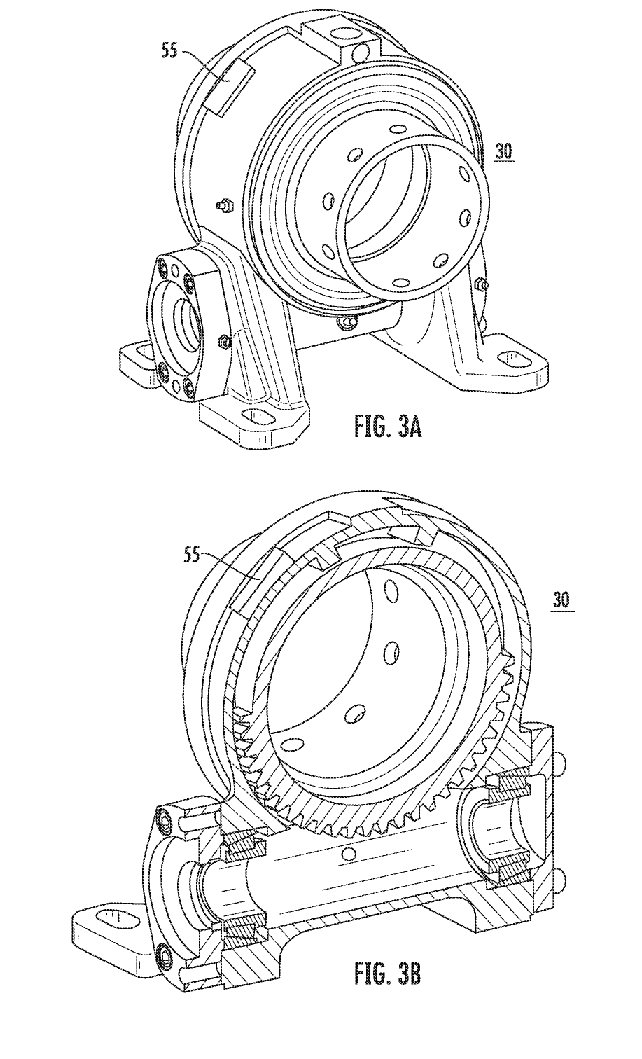

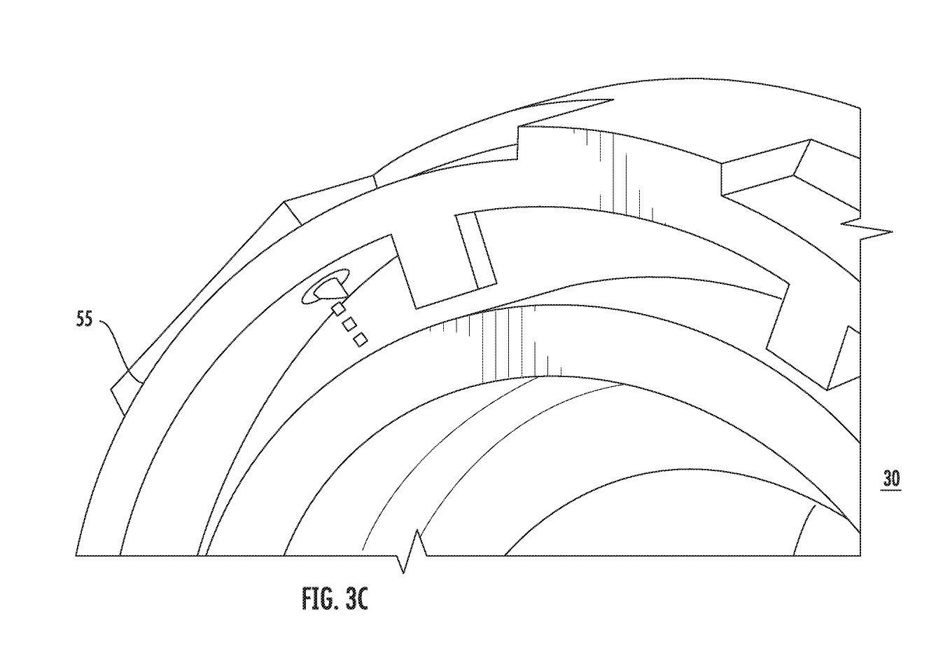

Turning to FIGS. 3A, 3B, and 3C, an absolute position sensing system 55 is illustrated. Position sensing system 55 is mounted in housing 32 and extends into the inner cavity of housing 32 to adjacent an outer surface of rotor assembly 38. While different sensors might be devised, in this embodiment the preferred structure includes a movement tracking device using an optical laser system similar to that used in an optical mouse in conjunction with a computer. The movement tracking device measures changes in relative movement and in this fashion position sensing system 55 can read specific position signatures on gear plate 40 or relative position changes as gear plate 40 rotates.

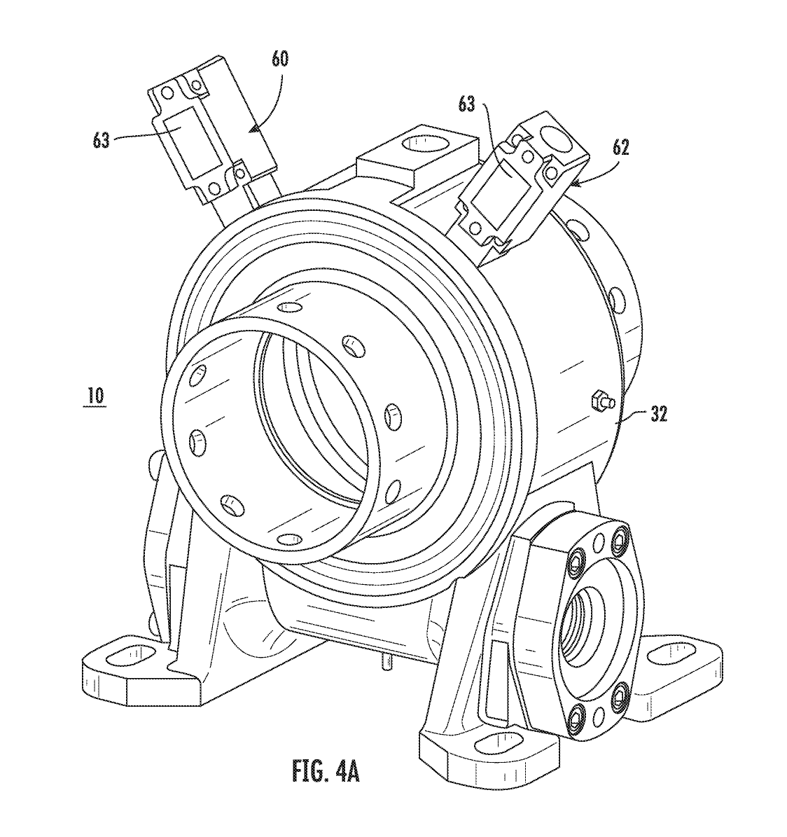

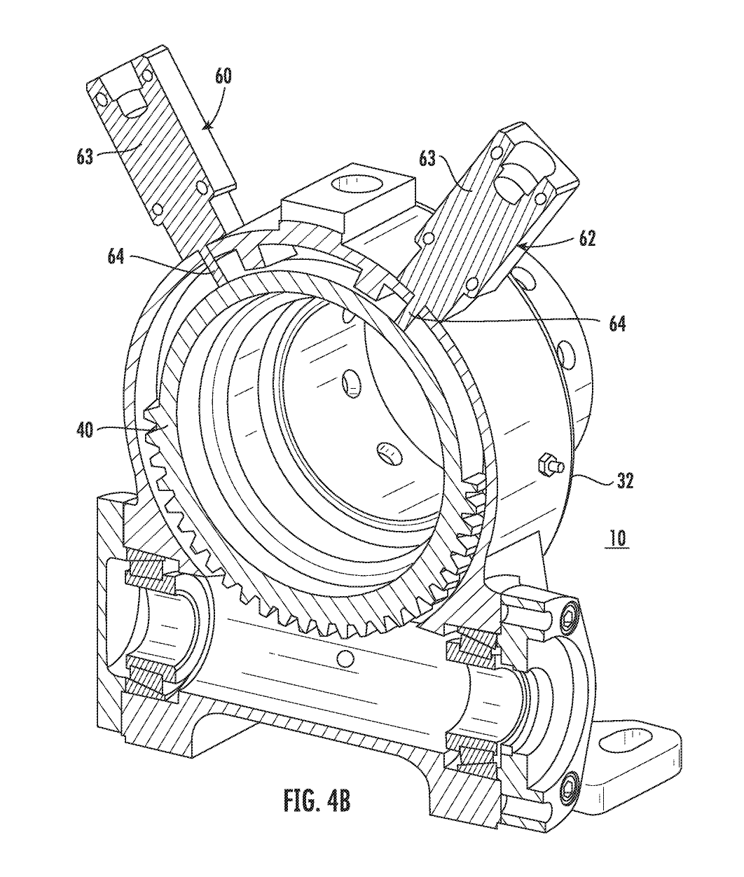

Turning to FIGS. 4A and 4B, limit switches 60 and 62 are illustrated. Each limit switch 60 and 62 include a body 63 mounted on the outer periphery of housing 32 and an activating arm or plunger 64 one end of which extends into the inner chamber to a position adjacent the outer periphery of gear plate 40. Limit switches 60 and 62 are further positioned so that plunger 64 of limit switch 60 is depressed by the left end gear tooth (in FIG. 4B) when the worm gear drives rotor assembly 38 clockwise and plunger 64 of limit switch 62 is depressed by the right end gear tooth (in FIG. 4B) when the worm gear drives rotor assembly 38 counterclockwise. As will be understood, when either plunger 64 is depressed it activates limit switch 60 or 62 which signals the drive mechanism to stop and reverse direction. Integrating a limit switch into the drive system in this manner eliminates the need for additional parts to hold switches.

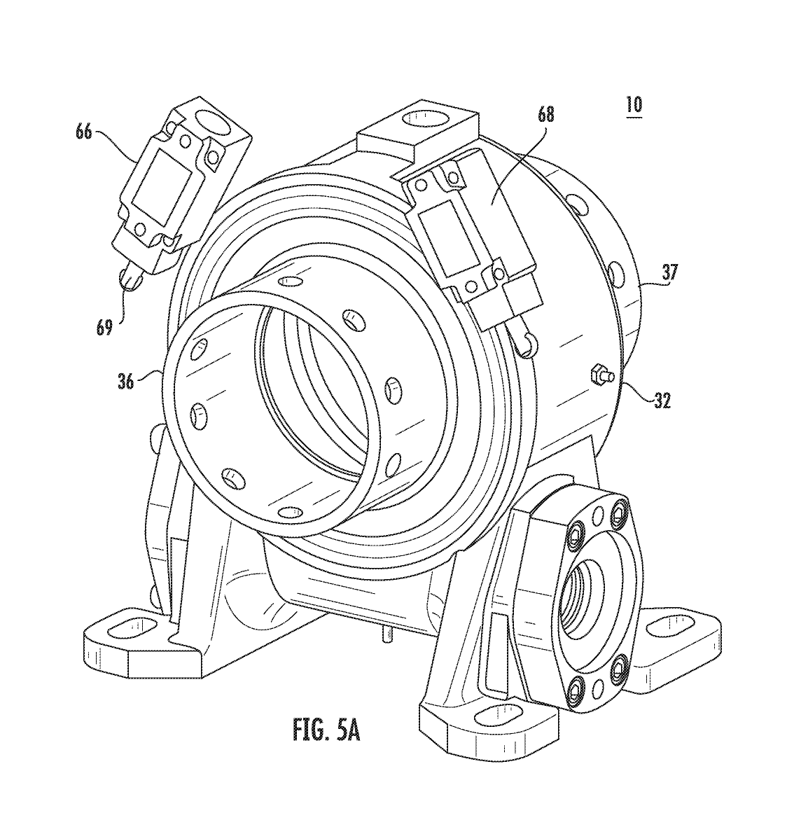

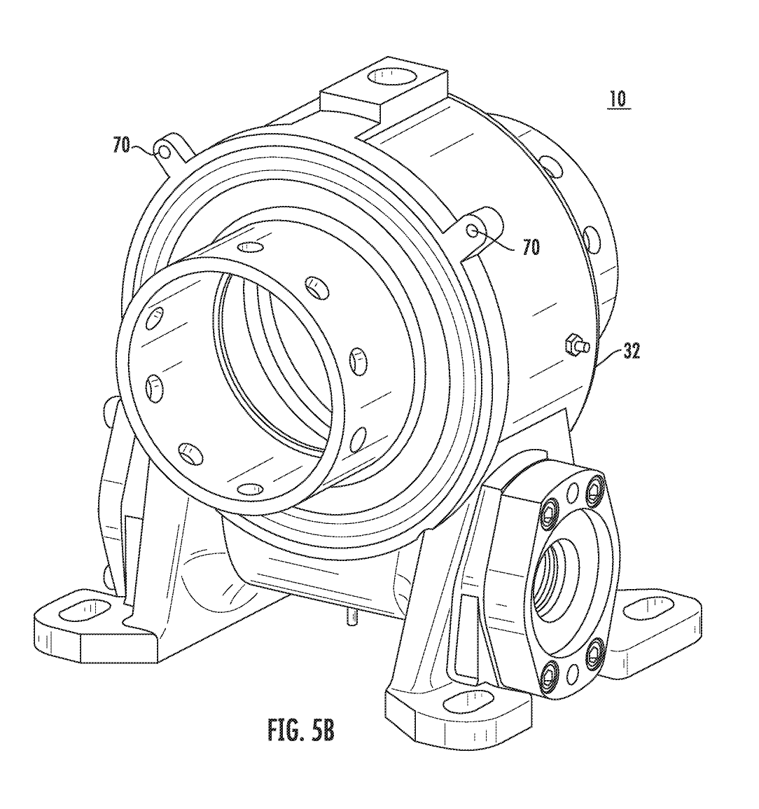

Turning to FIGS. 5A and 5B, alternative limit switches 66 and 68 are illustrated which are externally mounted and activated. Limit switches 66 and 68 are basically the same as switches 60 and 62, described above, except that they are mounted on mounting features 70. In this preferred embodiment mounting features 70 are ears that extend outwardly and are formed integrally with housing 32. Limit switches 66 and 68 are attached to ears 70 by means of some attachment device, such as bolts, screws, etc. Further, limit switches 66 and 68 are positioned so that activating arms or plungers 69 will engage an external feature such as a protrusion of some sort (not shown) on the outer periphery of rotor assembly 38 or a part of the mounting assembly attaching solar panels 18 to output collars 36 or 37. It will be understood that the mounting points for limit switches 66 and 68 could be at substantially any desired position (generally determined prior to producing housing 32) and not just at the points shown.

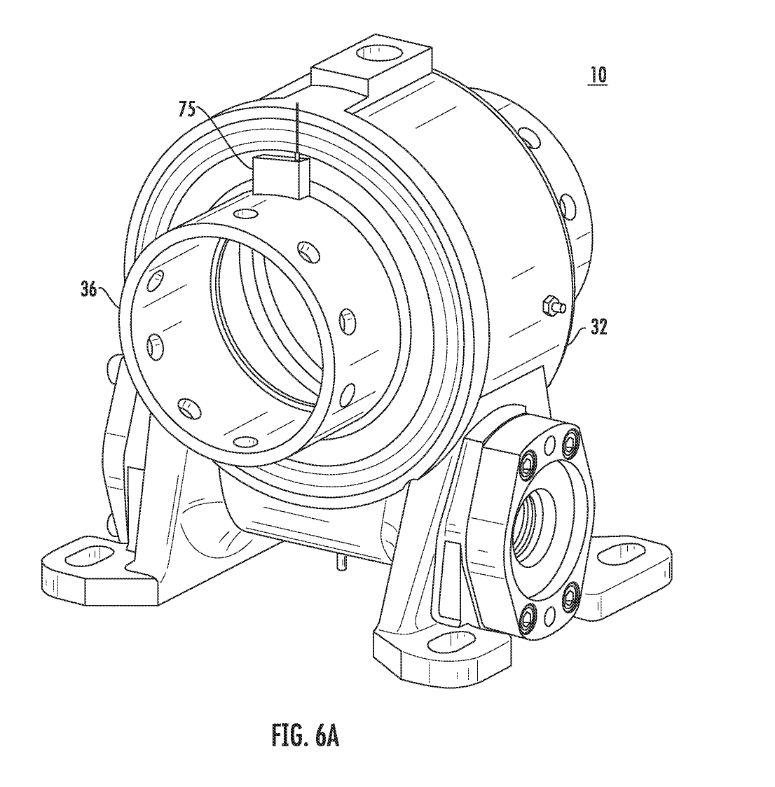

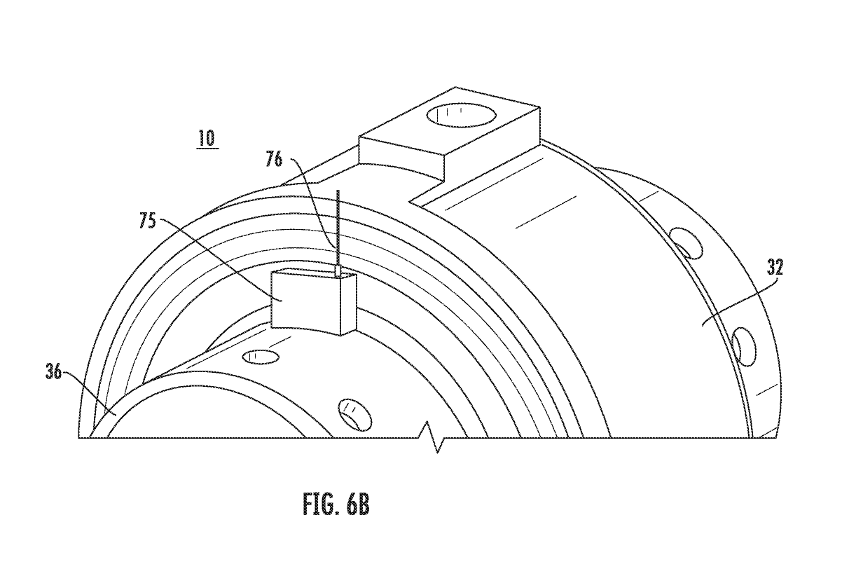

Turning now to FIGS. 6A and 6B, integrated accelerometer and communication assemblies, generally designated 75, are illustrated. Assemblies 75 are small electronic devices and/or circuits, such as accelerometers, GPS and communications protocols (e.g. Wifi or Zigbee), etc. Assemblies 75 are integrated/connected directly onto one of output collars 36 or 37 or gear plate 40 to directly measure output and communicate the measurements back to an existing control system. As understood by the artisan, accelerometers will sense the movement of output collars 36 or 37 or gear plate 40 and provide the information directly to the communications device. In this preferred embodiment, the communication is achieved by way of an antenna 76 of the communications device through a short range wireless system but it will be understood that other connection means (e.g. flexible wires) could be used.

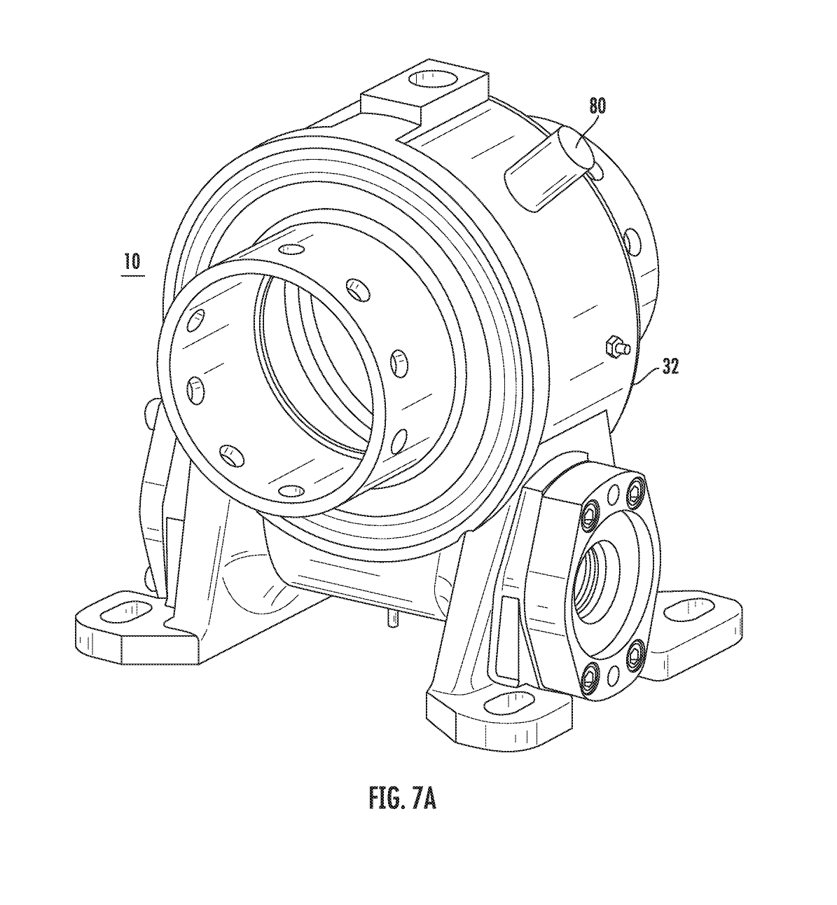

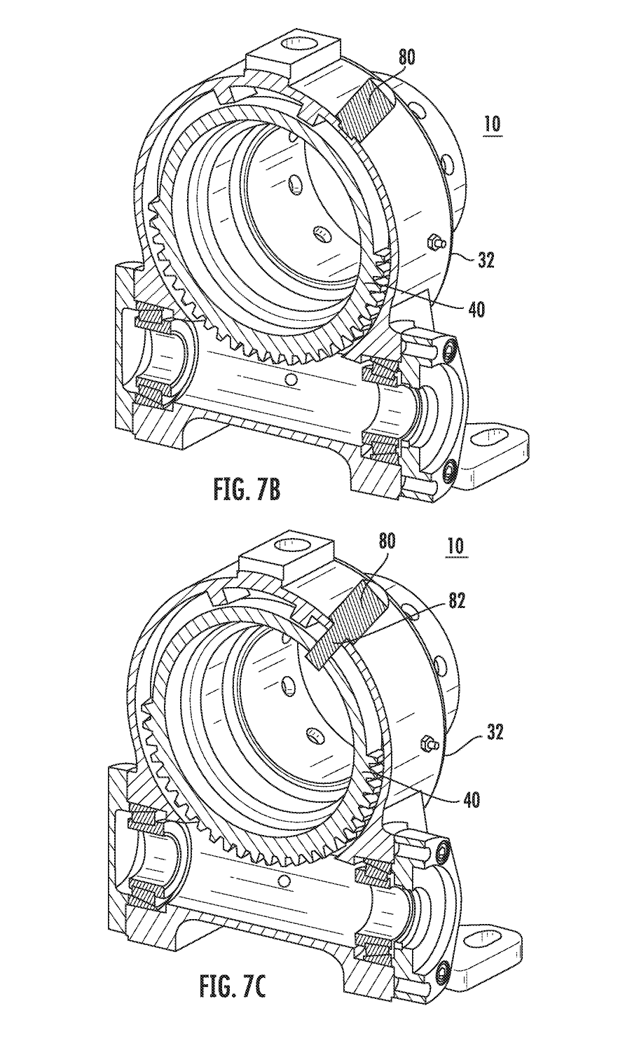

Turning now to FIGS. 7A, 7B, and 7C, an integrated torque routing solenoid 80 is illustrated. Solenoid 80 is mounted on the outer periphery of housing 32 with an armature 82 (see FIG. 7C) extending through an opening in housing 32. Further, armature 82 will extend through the opening in housing 32 and into an opening in gear plate 40 when solenoid 80 is de-energized or in the extended position, illustrated in FIG. 7C. As will be understood by the artisan, the opening in gear plate 40 will generally be positioned so that armature 82 engages it when solar panels 18 are in the stow position. When gear plate 40 and solar panels 18 are being driven, solenoid 82 is retracted, as illustrated in FIG. 7B. Thus, solenoid 80 helps route torque within solar panel assembly 10 by routing torque applied to output collars 36 and 37 directly to housing 32. An example of torque applied to output collars 36 and 37 is wind pressure on solar panel assembly 10. When solar panel assembly 10 is being driven and armature 82 of solenoid 80 is retracted, the dynamic torque in solar panel assembly 10 is all translated through the worm gear and gear plate 40. As will be understood, with armature 82 of solenoid 80 extended, torque experienced by gear plate 40 through forces applied to output collars 36 and 37 will be translated by shear into housing 32 as well as through the gear teeth/worm thread interface. Thus, solenoid 80 increases the ultimate holding torque of a given solar panel assembly design without changing the gear teeth/worm thread, housing structure and/or bearing design.

Thus, the present invention discloses and provides a new and improved slew drive with integrated sensors and transducers. While there are many application for the present slew drive, a specific application of the slew drive is illustrated as a solar tracker slew drive that is inexpensive, and easy and efficient to operate. Thus, the present invention discloses and provides a new and improved solar tracker slew drive with integrated sensors and transducers that is inexpensive, and easy and efficient to operate. The new and improved solar tracker slew drive with integrated sensors and transducers is simpler to incorporate into a solar panel assembly and is able to withstand higher external forces without substantially changing the structure.

Various changes and modifications to the embodiments herein chosen for purposes of illustration will readily occur to those skilled in the art. To the extent that such modifications and variations do not depart from the spirit of the invention, they are intended to be included within the scope thereof which is assessed only by a fair interpretation of the following claims.

Having fully described the invention in such clear and concise terms as to enable those skilled in the art to understand and practice the same, the invention claimed is:

1. A single axis slew driving system with integrated sensors and transducers comprising:
A slew drive including a housing with a central portion defining a cavity, a rotor assembly rotatably mounted within the cavity and supporting an output axle, the rotor assembly including a gear plate affixed to the axle and including an arcuate set of gear teeth positioned along a periphery thereof, a driving gear rotatably mounted in the housing so as to mesh with the arcuate set of gear teeth on the gear plate in the cavity in the housing; and
at least one of:
a thermocouple embedded in the housing so as to extend within the cavity to provide an indication of the temperature adjacent the driving gear chamber at contact points of the driving gear and the arcuate set of gear teeth on the gear plate and external monitoring apparatus;
an absolute position sensing system including a movement tracking device mounted in the housing and extending into the cavity of the housing and into communication with an outer surface of the rotatably positioned rotor assembly;
limit switches mounted on the outer periphery of the housing, a first of the limit switches including an activating plunger with an end positioned to be depressed when the driving gear drives the gear plate clockwise to a first rotary limit and a second of the limit switches including an activating plunger with an end positioned to be depressed when the driving gear drives the gear plate counterclockwise to a second rotary limit;
an integrated accelerometer and communication assembly including an accelerometer coupled to a communications protocol, the assembly integrated directly onto one of the output axle or the gear plate directly measuring rotary movement and communicating the measurements to an external control system; and
an integrated torque routing solenoid mounted on an outer periphery of the housing, the solenoid including an armature having an extended position and a withdrawn position, and in the extended position the armature extending through an opening in the housing and into an opening in the gear plate.

2. The single axis driving system with integrated sensors and transducers as claimed in claim 1 wherein the driving gear includes a worm gear rotatably mounted in a cylindrical cavity portion of the housing, and the thermocouple is embedded in the cylindrical cavity portion of the housing to provide an indication of the temperature adjacent the worm gear.

3. The single axis driving system with integrated sensors and transducers as claimed in claim 1 including the absolute position sensing system, the absolute position sensing system includes a movement tracking device using an optical laser system in conjunction with a computer.

4. The single axis driving system with integrated sensors and transducers as claimed in claim 1 including the limit switches, each limit switch including a body mounted on the outer periphery of the housing and an activating plunger positioned so that one end extends into the housing cavity to adjacent a rotor assembly outer periphery, the limit switches being further positioned so that the plunger of a first limit switch is depressed by an end gear tooth of the arcuate set of gear teeth when the driving gear rotates clockwise to a first limit and so that the plunger of a second limit switch is depressed by an end gear tooth of the arcuate set of gear teeth when the driving gear rotates counterclockwise to a second limit.

5. The single axis driving system with integrated sensors and transducers as claimed in claim 1 including the limit switches, each limit switch including a body mounted on a mounting feature integrally provided on an outer surface of the housing, protrusions mounted on an externally accessible outer surface of the rotor assembly, and each limit switch further including an activating plunger, a first limit switch plunger being positioned so that one end engages a protrusion when the driving gear rotates clockwise to a first limit and a second limit switch plunger being positioned so that one end engages a protrusion when the driving gear rotates counterclockwise to a second limit.

6. The single axis driving system with integrated sensors and transducers as claimed in claim 1 further incorporated into a solar tracking system.

7. The single axis driving system with integrated sensors and transducers as claimed in claim 6 further including solar panels attached to the output axle for rotation therewith.

8. The single axis driving system with integrated sensors and transducers as claimed in claim 1 further including a drive motor mounted on the housing and attached to the driving gear for rotation of the driving gear, whereby the rotor assembly including the gear plate and attached output axle are rotated in response to rotation of the drive motor.

9. A single axis slew driving system with integrated sensors and transducers comprising:
a housing with a central portion defining a cavity;
a rotor assembly rotatably mounted within the cavity and supporting an output axle, the rotor assembly including a gear plate affixed to the axle and including an arcuate set of gear teeth positioned along a periphery thereof;
a driving gear rotatably mounted in the housing so as to mesh with the arcuate set of gear teeth on the gear plate in the cavity in the housing; and
at least one of:
a thermocouple embedded in the housing so as to extend within the cavity to provide an indication of the temperature adjacent the driving gear chamber at contact points of the driving gear and the arcuate set of gear teeth on the gear plate and external monitoring apparatus;
an absolute position sensing system including a movement tracking device mounted in the housing and extending into the cavity of the housing and into communication with an outer surface of the rotatably positioned rotor assembly;
limit switches mounted on the outer periphery of the housing, a first of the limit switches including an activating plunger with an end positioned to be depressed when the driving gear drives the gear plate clockwise to a first rotary limit and a second of the limit switches including an activating plunger with an end positioned to be depressed when the driving gear drives the gear plate counterclockwise to a second rotary limit;
an integrated accelerometer and communication assembly including an accelerometer coupled to a communications protocol, the assembly integrated directly onto one of the output axle or the gear plate directly measuring rotary movement and communicating the measurements to an external control system; and
an integrated torque routing solenoid mounted on an outer periphery of the housing, the solenoid including an armature having an extended position and a withdrawn position, and in the extended position the armature extending through an opening in the housing and into an opening in the gear plate.

10. The single axis driving system with integrated sensors and transducers as claimed in claim 9 wherein the driving gear includes a worm gear rotatably mounted in a cylindrical cavity portion of the housing, and the thermocouple is embedded in the cylindrical cavity portion of the housing to provide an indication of the temperature adjacent the worm gear.

11. The single axis driving system with integrated sensors and transducers as claimed in claim 9 including the absolute position sensing system, the absolute position sensing system includes a movement tracking device using an optical laser system in conjunction with a computer.

12. The single axis driving system with integrated sensors and transducers as claimed in claim 9 including the limit switches, each limit switch including a body mounted on the outer periphery of the housing and an activating plunger positioned so that one end extends into the housing cavity to adjacent a rotor assembly outer periphery, the limit switches being further positioned so that the plunger of a first limit switch is depressed by an end gear tooth of the arcuate set of gear teeth when the driving gear rotates clockwise to a first limit and so that the plunger of a second limit switch is depressed by an end gear tooth of the arcuate set of gear teeth when the driving gear rotates counterclockwise to a second limit.

13. The single axis driving system with integrated sensors and transducers as claimed in claim 9 including the limit switches, each limit switch including a body mounted on a mounting feature integrally provided on an outer surface of the housing, protrusions mounted on an externally accessible outer surface of the rotor assembly, and each limit switch further including an activating plunger, a first limit switch plunger being positioned so that one end engages a protrusion when the driving gear rotates clockwise to a first limit and a second limit switch plunger being positioned so that one end engages a protrusion when the driving gear rotates counterclockwise to a second limit.

14. The single axis driving system with integrated sensors and transducers as claimed in claim 9 further incorporated into a solar tracking system.

15. The single axis driving system with integrated sensors and transducers as claimed in claim 9 further including a drive motor mounted on the housing and attached to the driving gear for rotation of the driving gear, whereby the rotor assembly including the gear plate and attached output axle are rotated in response to rotation of the drive motor.

16. A single axis slew driving system with integrated sensors and transducers comprising:
a housing with a central portion defining a cavity;
a rotor assembly rotatably mounted within the cavity and supporting an output axle, the rotor assembly including a gear plate affixed to the axle and including an arcuate set of gear teeth positioned along a periphery thereof;
a worm gear rotatably mounted in a cylindrical cavity portion of the housing so as to mesh with the arcuate set of gear teeth on the gear plate in the cavity in the housing; and
at least one of:
a thermocouple embedded in the housing so as to extend within the cavity to provide an indication of the temperature adjacent the worm gear chamber at contact points of the worm gear and the arcuate set of gear teeth on the gear plate and external monitoring apparatus;
an absolute position sensing system including a movement tracking device mounted in the housing and extending into the cavity of the housing and into communication with an outer surface of the rotatably positioned rotor assembly;
limit switches mounted on the outer periphery of the housing, a first of the limit switches including an activating plunger with an end positioned to be depressed when the driving gear drives the gear plate clockwise to a first rotary limit and a second of the limit switches including an activating plunger with an end positioned to be depressed when the driving gear drives the gear plate counterclockwise to a second rotary limit;
an integrated accelerometer and communication assembly including an accelerometer coupled to a communications protocol, the assembly integrated directly onto one of the output axle or the gear plate directly measuring rotary movement and communicating the measurements to an external control system; and
an integrated torque routing solenoid mounted on an outer periphery of the housing, the solenoid including an armature having an extended position and a withdrawn position, and in the extended position the armature extending through an opening in the housing and into an opening in the gear plate.

17. The single axis driving system with integrated sensors and transducers as claimed in claim 16 further including a thermocouple embedded in the cylindrical cavity portion of the housing to provide an indication of the temperature adjacent the worm gear.

18. The single axis driving system with integrated sensors and transducers as claimed in claim 16 including the absolute position sensing system, the absolute position sensing system including a movement tracking device using an optical laser system in conjunction with a computer.

19. The single axis driving system with integrated sensors and transducers as claimed in claim 16 including the limit switches, each limit switch including a body mounted on the outer periphery of the housing and an activating plunger positioned so that one end extends into the housing cavity to adjacent a rotor assembly outer periphery, the limit switches being further positioned so that the plunger of a first limit switch is depressed by an end gear tooth of the arcuate set of gear teeth when the driving gear rotates clockwise to a first limit and so that the plunger of a second limit switch is depressed by another end gear tooth of the arcuate set of gear teeth when the driving gear rotates counterclockwise to a second limit.

20. The single axis driving system with integrated sensors and transducers as claimed in claim 16 including the limit switches, each limit switch including a body mounted on a mounting feature integrally provided on an outer surface of the housing, protrusions mounted on an externally accessible outer surface of the rotor assembly, and each limit switch further including an activating plunger, a first limit switch plunger being positioned so that one end engages a protrusion when the driving gear rotates clockwise to a first limit and a second limit switch plunger being positioned so that one end engages a protrusion when the driving gear rotates counterclockwise to a second limit.

21. The single axis driving system with integrated sensors and transducers as claimed in claim 16 further incorporated into a solar tracking system.

22. The single axis driving system with integrated sensors and transducers as claimed in claim 21 further including solar panels attached to the output axle for rotation therewith.

23. The single axis driving system with integrated sensors and transducers as claimed in claim 16 further including a drive motor mounted on the housing and attached to the worm gear for rotation of the worm gear, whereby the rotor assembly including the gear plate and attached output axle are rotated in response to rotation of the drive motor.
